(19) United States
(12) Patent Application Publication
(10) Pub. No.: US 2026/0274063 A1
(43) Pub. Date: Sep. 17, 2026

(54) HUB MOTOR DRIVE SYSTEM AND VEHICLE

(71) Applicant: Schaeffler Technologies AG & Co. KG, Herzogenaurach (DE)

(72) Inventor: Xiangyang Cai, Shanghai (CN)

(73) Assignee: Schaeffler Technologies AG & Co. KG, Herzogenaurach (DE)

(21) Appl. No.: 19/163,846

(22) PCT Filed: Dec. 26, 2023
(86) PCT No.: PCT/CN2023/141867

§ 371 Date: Sep. 10, 2025

(30) Foreign Application Priority Data
Mar. 14, 2023 (CN) 202310265654.6

(51) Int. Cl. B60K 7/00; B60K 17/04; B60T 1/06; H02K 7/00; H02K 7/102; H02K 7/116

(52) U.S. Cl. CPC B60K 7/0007; B60K 17/046; B60T 1/065; H02K 7/003; H02K 7/102; H02K 7/116

(57) ABSTRACT

A hub motor drive system includes an output shaft, a motor, a planetary gear reduction mechanism, a sun gear, planetary gear carriers, a braking mechanism, a brake disc assembly and a brake caliper assembly. The planetary gear reduction mechanism is located on the other side relative to and arranged side by side with the motor along the axial direction. The sun gear is in transmission connection with a rotor, and the planetary gear carriers are in transmission connection with the output shaft. The braking mechanism is located on the other side relative to and arranged side by side with the motor in the axial direction. The brake disc assembly is mounted in a torsion resistant manner on the output shaft. The brake caliper assembly overlaps the planetary gear reduction mechanism in a radial direction and the brake disc assembly overlaps the planetary gear reduction mechanism in the axial direction.

### CROSS-REFERENCE TO RELATED APPLICATIONS

This application is the United States National Phase of PCT Appln. No. PCT/CN 2023/141867 filed Dec. 26, 2023, which claims priority to Chinese patent application no. 202310265654.6, filed on Mar. 14, 2023 and entitled “HUB MOTOR DRIVE SYSTEM AND VEHICLE”, the entire content of which is incorporated herein by reference.

### TECHNICAL FIELD

The present disclosure relates to the field of vehicles, for example, electric vehicles, etc., in particular to a hub motor drive system for a vehicle and a vehicle including the hub motor drive system.

### BACKGROUND

In the prior art, new energy vehicles, for example, electric vehicles, etc., still mainly use a drive system having a central motor, a clutch, a transmission and a differential, which leads to excessive components of the drive system and a longer torque transmission path, such that the drive system has high power loss and low efficiency, seriously affecting driving distances of the new energy vehicles. Therefore, technicians have developed a hub motor drive system with a relatively short torque transmission path to solve the above problems.

An existing hub motor drive system integrates a motor, a transmission mechanism and a braking mechanism of wheels, etc. However, the layout of these components in the existing hub motor drive system is unreasonable, resulting in excessive dimensions (especially axial dimensions) of the entire hub motor drive system and thus excessive space occupation, which further generates adverse effects on dimensions of wheels comprising the hub motor drive system and the structural layout of the vehicle (such as the layout of a suspension system).

### SUMMARY

The present application has been made based on the defects of the prior art as described above. One objective of the present application is to provide a novel hub motor drive system that is capable of reducing the overall dimensions of the system, particularly shortening axial dimensions, compared with an existing hub motor drive system, thereby reducing adverse effects of the hub motor drive system on the dimensions of wheels and the structural layout of a vehicle. Another objective of the present application is to provide a vehicle comprising the above-mentioned hub motor drive system.

To achieve the above-mentioned invention objectives, the present application adopts the following technical solutions.

The present application provides a hub motor drive system as follows, having an axial direction, a radial direction and a circumferential direction, wherein the hub motor drive system includes:
an output shaft, an end portion on one side in the axial direction of the output shaft being used for being fixed to hubs of wheels;
a motor including a stator and a rotor;
a planetary gear reduction mechanism being located on the other side in the axial direction relative to the motor and being arranged side by side with the motor in the axial direction, the planetary gear reduction mechanism including a sun gear and planetary gear carriers, the sun gear being in transmission connection with the rotor, and the planetary gear carriers being in transmission connection with the output shaft; and
a braking mechanism being located on the other side in the axial direction relative to the motor and being arranged side by side with the motor in the axial direction, the braking mechanism including a brake disc assembly and a brake caliper assembly, the brake disc assembly being mounted in a torsion resistant manner on the output shaft, the brake caliper assembly being capable of generating friction torque with the brake disc assembly in a controlled manner, the brake caliper assembly overlapping the planetary gear reduction mechanism in the radial direction, and the brake disc assembly overlapping the planetary gear reduction mechanism in the axial direction.

In one optional solution, the brake caliper assembly includes a portion on one side in the axial direction, located on one side in the axial direction, relative to the brake disc assembly. The portion on one side in the axial direction is located on a radially outer side of the planetary gear reduction mechanism, and the portion on one side in the axial direction overlaps the planetary gear reduction mechanism in the radial direction.

In another optional solution, the brake disc assembly includes a brake disc, a spline hub, and a thermal insulation pad which are assembled together. The brake caliper assembly is used for generating friction torque with the brake disc, the brake disc is in indirect transmission connection with the output shaft via the spline hub, and the thermal insulation pad is located between the brake disc and the spline hub.

In another optional solution, the brake disc assembly includes a brake disc, the brake caliper assembly is used for generating friction torque with the brake disc, and the brake disc is in direct transmission connection with the output shaft.

In another optional solution, a housing assembly is further included, and the housing assembly defines a first space, a second space, and a third space which are partitioned from each other. The motor is at least partially accommodated and mounted in the first space, the planetary gear reduction mechanism is at least partially accommodated and mounted in the second space, and the braking mechanism is at least partially accommodated in the third space. A radially outer side portion of the first space and a radially outer side portion of the third space are adjacent to each other in the axial direction, and a radially inner side portion of the first space and a radially inner side portion of the third space are partitioned by the second space.

In another optional solution, the second space overlaps both the first space and the third space in the radial direction.

In another optional solution, the housing assembly includes a housing main body and a back plate. The back plate is assembled to the housing main body from the other side in the axial direction, the brake caliper assembly is fixed to the back plate, and the back plate is used for being mounted on a suspension system of a vehicle.

In another optional solution, a steering knuckle and a wheel bearing are further included.

The output shaft includes a first flange portion and a first shaft portion fixed to each other, the first shaft portion extends from the first flange portion toward the other side in the axial direction, and the first flange portion is used for being fixed to the hubs.

The steering knuckle includes a second flange portion and a second shaft portion fixed to each other. The second flange portion and the back plate are fixed, the second shaft portion extends from the second flange portion toward one side in the axial direction and is inserted into the first shaft portion, and the wheel bearing is located between the first shaft portion and the second shaft portion.

In another optional solution, the motor is a radial magnetic field motor. The motor also includes a rotor bracket and a motor shaft, and the rotor is in indirect transmission connection with the sun gear via the rotor bracket and the motor shaft.

In another optional solution, the motor is an axial flow motor, the motor also includes a motor shaft, and the rotor is in indirect transmission connection with the sun gear via the motor shaft.

In another optional solution, an inverter assembly for a motor is further included. The inverter assembly is located on a radially outer side of the planetary gear reduction mechanism and is arranged side by side with the portion on one side in the axial direction of the brake caliper assembly in the circumferential direction.

The present application further provides a vehicle as follows, including the hub motor drive system according to any one of the preceding technical solutions.

By adopting the above-mentioned technical solutions, the present application provides a novel hub motor drive system and a vehicle including the hub motor drive system. The hub motor drive system includes an output shaft, a motor, a planetary gear reduction mechanism, and a braking mechanism which are assembled together. The planetary gear reduction mechanism is arranged side by side with the motor in an axial direction and is used for transmitting torque between the motor and the output shaft. The braking mechanism is arranged side by side with the motor in the axial direction and comprises a brake disc assembly and a brake caliper assembly.

The brake disc assembly is mounted in a torsion resistant manner on the output shaft, and the brake caliper assembly is capable of generating friction torque with the brake disc assembly in a controlled manner. The brake caliper assembly overlaps the planetary gear reduction mechanism in a radial direction, and the brake disc assembly overlaps the planetary gear reduction mechanism in the axial direction. It can be understood that the brake caliper assembly overlapping the planetary gear reduction mechanism in the radial direction herein means that when observed along at least one radial direction, projections of the brake caliper assembly and the planetary gear reduction mechanism on a projection surface perpendicular to the radial direction are at least partially overlapped.

In this way, the motor is arranged side by side with the planetary gear reduction mechanism and the braking mechanism in the axial direction, and the planetary gear reduction mechanism overlaps the brake caliper assembly of the braking mechanism in the radial direction. Therefore, an axial length of the entire hub motor drive system can be determined by the motor and the braking mechanism, that is, the axial length of the entire hub motor drive system is basically equal to a sum of axial lengths of both the motor and the braking mechanism. Thus, compared with the existing hub motor drive system, the overall dimensions of the system can be reduced, especially the axial dimensions can be shortened, thereby being capable of reducing adverse effects of the axial length of the hub motor drive system on the dimensions of wheels and the structural layout of the vehicle (the layout of a suspension system).

### BRIEF DESCRIPTION OF THE DRAWINGS

FIG. 1A is a cross-sectional schematic diagram showing a hub motor drive system according to a first embodiment of the present application.

FIG. 1B is a three-dimensional schematic diagram showing the hub motor drive system in FIG. 1A.

FIG. 1C is another three-dimensional schematic diagram showing the hub motor drive system in FIG. 1A.

FIG. 2A is a cross-sectional schematic diagram showing a hub motor drive system according to a second embodiment of the present application.

FIG. 2B is a three-dimensional schematic diagram showing the hub motor drive system in FIG. 2A.

FIG. 2C is another three-dimensional schematic diagram showing the hub motor drive system in FIG. 2A.

FIG. 3A is a cross-sectional schematic diagram showing a hub motor drive system according to a third embodiment of the present application.

FIG. 3B is a three-dimensional schematic diagram showing the hub motor drive system in FIG. 3A.

FIG. 4A is a cross-sectional schematic diagram showing a hub motor drive system according to a fourth embodiment of the present application.

FIG. 4B is a three-dimensional schematic diagram showing the hub motor drive system in FIG. 4A.

FIG. 4C is a three-dimensional schematic diagram showing a local structure of the hub motor drive system in FIG. 4A.

### DETAILED DESCRIPTION

Exemplary embodiments of the present application are described below with reference to the accompanying drawings. It should be understood that these specific descriptions are only used for teaching those skilled in the art how to implement the present application and are neither intended to be exhaustive of all possible ways of the present application nor to limit the scope of the present application.

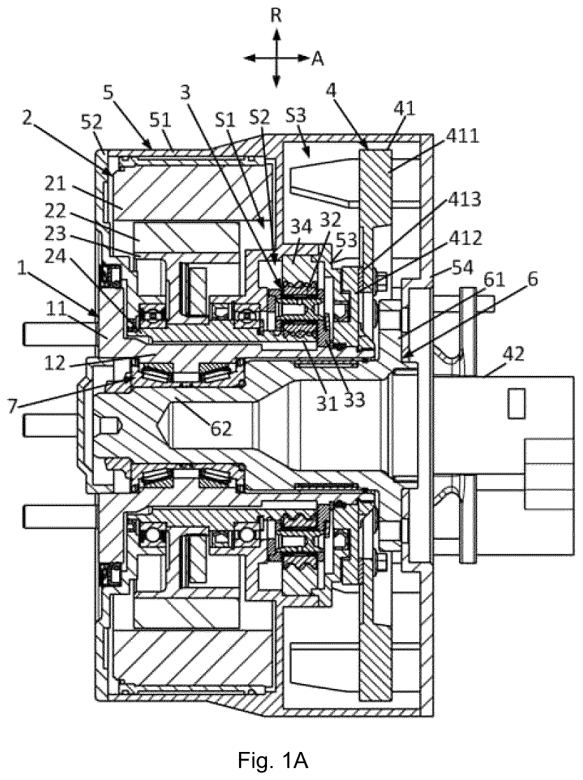

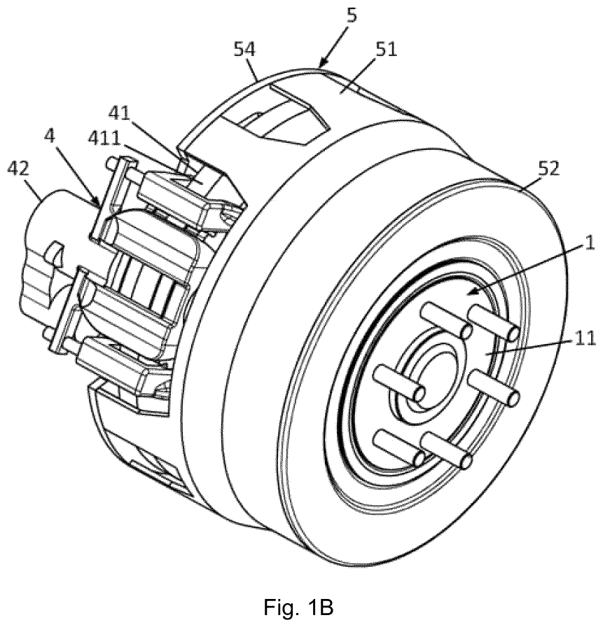

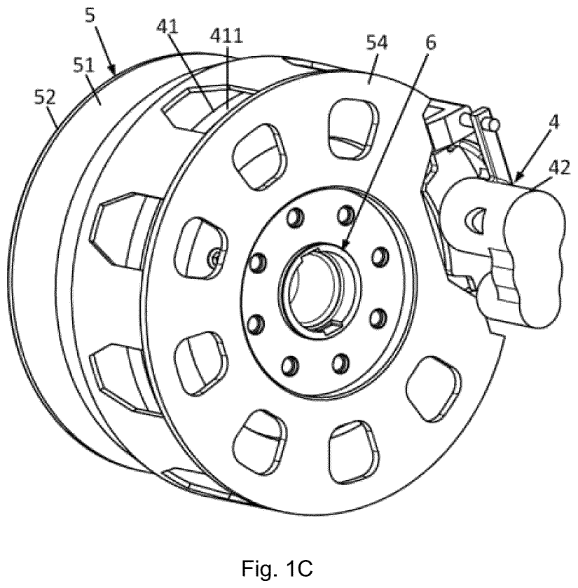

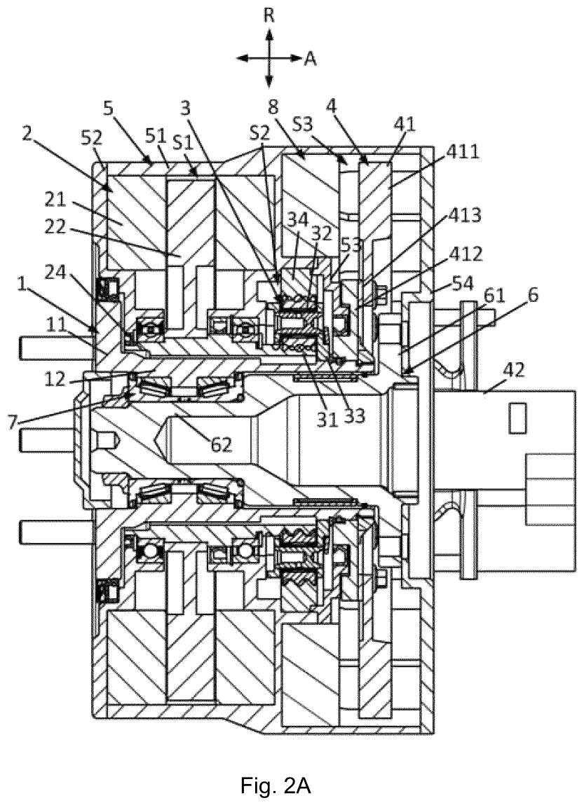

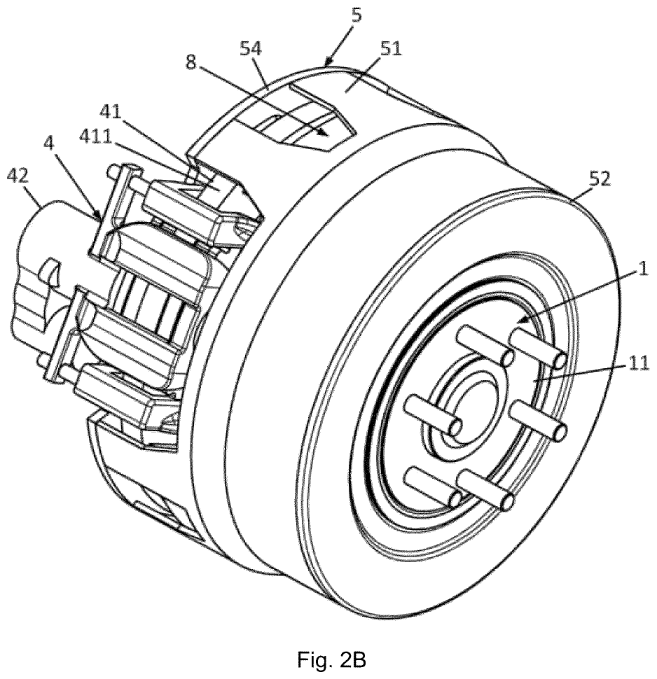

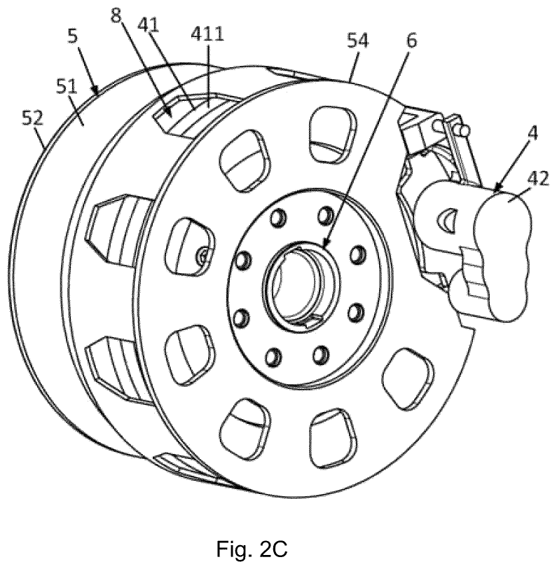

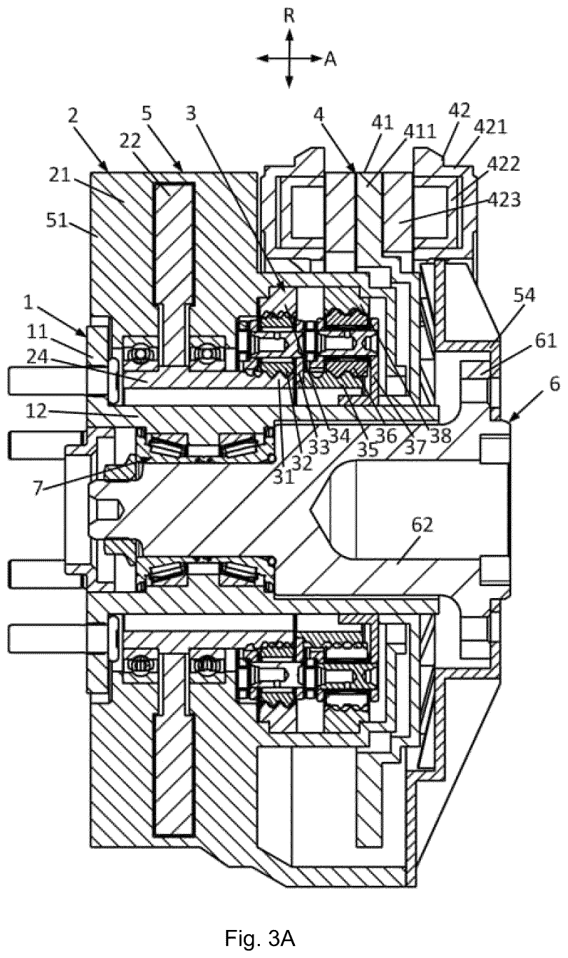

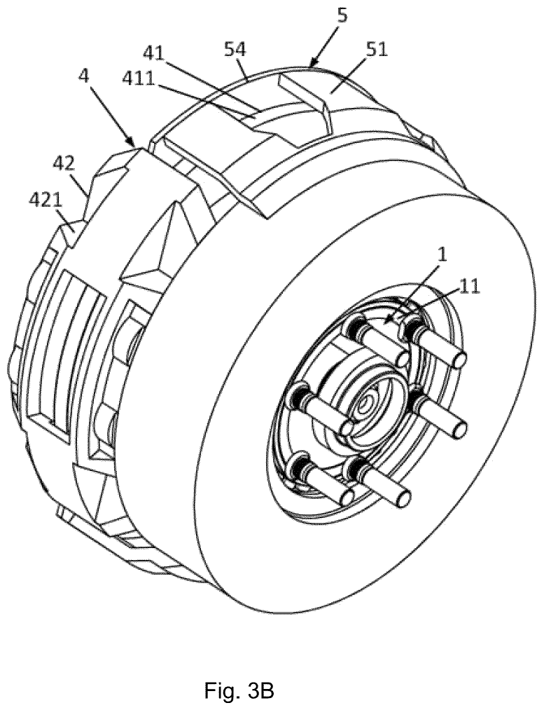

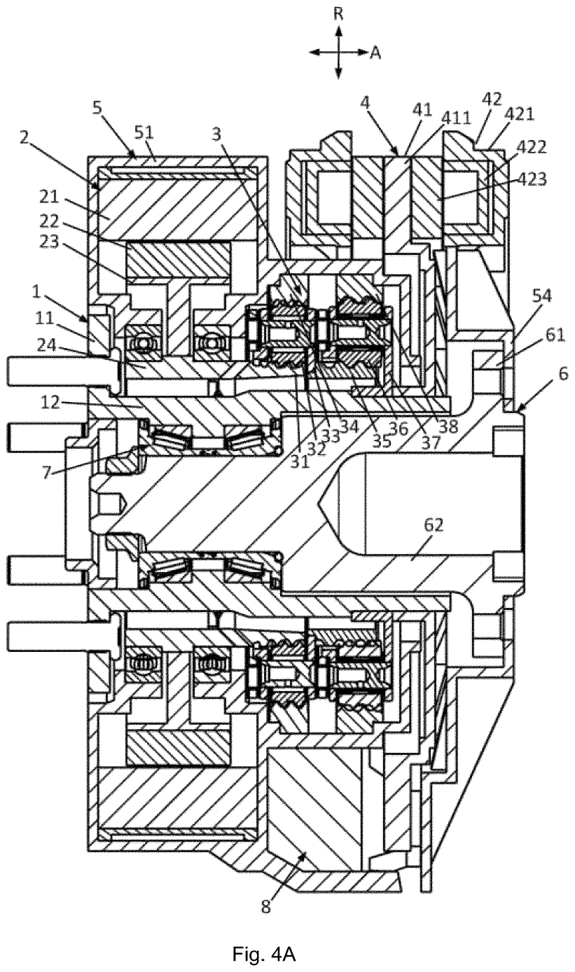

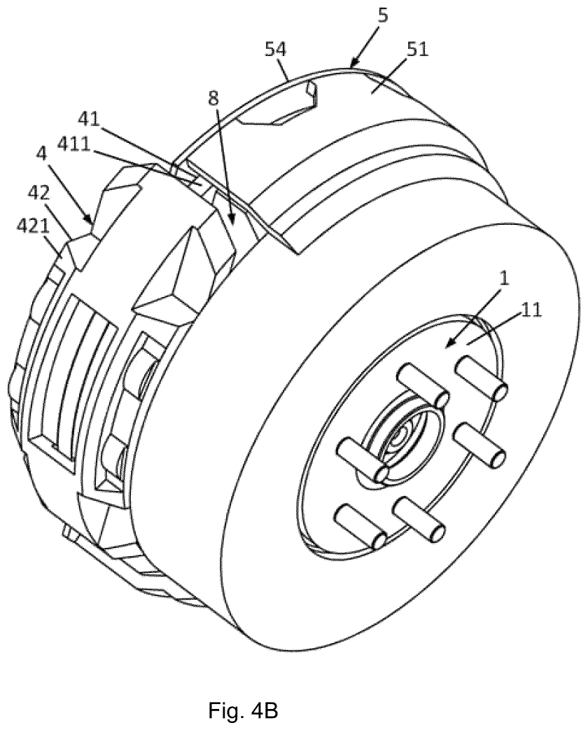

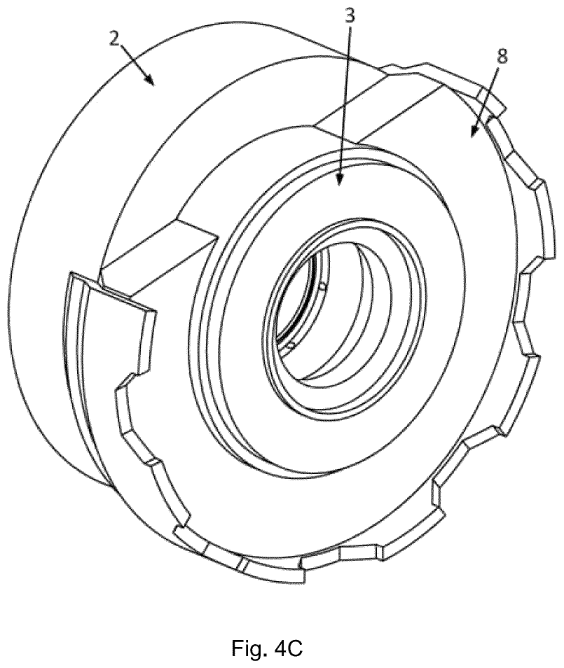

In the present application, a hub motor drive system comprises an output shaft, and other components are arranged coaxially with the output shaft. Unless otherwise specially stated, “axial direction”, “radial direction”, and “circumferential direction” refer to an axial direction, a radial direction, and a circumferential direction of the output shaft, respectively. “One side in the axial direction” refers to the left side in FIG. 1A, FIG. 2A, FIG. 3A, and FIG. 4A, and “the other side in the axial direction” refers to the right side in FIG. 1A, FIG. 2A, FIG. 3A, and FIG. 4A. “Radially outer side” refers to the side away from a central axis of the output shaft in the radial direction, and “radially inner side” refers to the side close to the central axis of the output shaft in the radial direction.

In the present application, “transmission connection” means that two components are connected in a manner of being capable of transmitting torque. “Direct transmission connection” means that transmission connection is achieved between two components using direct connection methods of a spline or direct fixation, etc. ; and “indirect transmission connection” means that transmission connection is achieved between two components through indirect connection methods of connecting members or other transmission mechanisms, etc.

In the present application, two components overlapping in a certain direction means that when observed along the direction, there is an at least partial overlapping relationship between projections of the two components on a projection surface perpendicular to the direction.

A hub motor drive system according to a first embodiment of the present application will be described below in combination with the accompanying drawings of the specification.

### The Hub Motor Drive System According to the First Embodiment of the Present Application

As shown in FIG. 1A to FIG. 1C, the hub motor drive system according to the first embodiment of the present application comprises an output shaft 1, a motor 2, a planetary gear reduction mechanism 3, a braking mechanism 4, a housing assembly 5, a steering knuckle 6, and a wheel bearing 7 which are assembled together. In the present embodiment, axial dimensions of the hub motor drive system are basically determined by the motor 2 and the braking mechanism 4 which are arranged side by side in an axial direction A. The planetary gear reduction mechanism 3 is located on a radially inner side of a brake caliper assembly 42 of the braking mechanism 4 and overlaps a portion on one side in the axial direction of the brake caliper assembly 42 in the radial direction R, and an axial length of the hub motor drive system will not increase additionally due to the planetary gear reduction mechanism 3.

In the present embodiment, as shown in FIG. 1A and FIG. 1B, the output shaft 1 is a hollow flanged shaft extending along the axial direction A. Specifically, the output shaft 1 comprises a first flange portion 11 and a first shaft portion 12 which are formed into a whole. The first flange portion 11 extends from an end portion on one side in the axial direction of the first shaft portion 12 toward a radially outer side, and the first flange portion 11 continuously extends over an entire circumference along the circumferential direction. A plurality of mounting holes are formed on the first flange portion 11, and mounting members, for example, hub bolts, passing through the plurality of mounting holes are capable of fixing the first flange portion 11 with hubs of wheels of a vehicle together. The first shaft portion 12 extends in a straight line shape from an inner circumferential portion of the first flange portion 11 toward the other side in the axial direction. The first shaft portion 12 is in direct transmission connection with a first planetary gear carrier 33 of the planetary gear reduction mechanism 3, and direct transmission connection between a spline hub 412 of a brake disc assembly 41 of the braking mechanism 4 and the first shaft portion 12 is achieved via a spline structure.

In the present embodiment, the motor 2 is a radial magnetic field motor. As shown in FIG. 1A, specifically, the motor 2 comprises a stator 21, a rotor 22, a rotor bracket 23, and a motor shaft 24. The stator 21 is fixed together with the housing assembly 5, and a cooling sleeve may be provided between the stator 21 and the housing assembly 5, for reducing the temperature of the stator 21 during the operation of the motor 2. The rotor 22 is located on a radially inner side of the stator 21 and is opposite to the stator 21 in the radial direction R, and the rotor 22 is capable of rotating relative to the stator 21. The rotor bracket 23 is located on a radially inner side of the rotor 22 and is fixed together with the rotor 22, and the rotor bracket 23 is further fixed together with the motor shaft 24, such that the rotor 22 is in indirect transmission connection with the motor shaft 24 via the rotor bracket 23. Further, a first sun gear 31 of the planetary gear reduction mechanism 3 is formed with the motor shaft 24 into a whole and is located at an end portion on the other side in the axial direction of the motor shaft 24.

In the present embodiment, the planetary gear reduction mechanism 3 is capable of transmitting torque from the motor 2 to the output shaft 1. Specifically, as shown in FIG. 1A, the planetary gear reduction mechanism 3 comprises the first sun gear 31, first planetary gears 32, a first planetary gear carrier 33, and a first ring gear 34 which are assembled together. As described above, gear teeth are formed on the end portion on the other side in the axial direction of the motor shaft 24 of the motor 2 to constitute the first sun gear 31 of the planetary gear reduction mechanism 3, that is, the first sun gear 31 and the motor shaft 24 are formed into a whole. The plurality of first planetary gears 32 are located on a radially outer side of the first sun gear 31 and are uniformly distributed along the circumferential direction, and each first planetary gear 32 is always meshed with the first sun gear 31, such that each first planetary gear 32 is capable of rotating around its respective central axis and revolving around the first sun gear 31 as the first sun gear 31 rotates. The first planetary gear carrier 33 is located on a radially outer side of the first sun gear 31, and the plurality of first planetary gears 32 are mounted on the first planetary gear carrier 33; and the first planetary gear carrier 33 is in direct transmission connection with the first shaft portion 12 of the output shaft 1. As the plurality of first planetary gears 32 revolve, the first planetary gear carrier 33 is capable of being driven to rotate, thereby driving the output shaft 1 to rotate. The first ring gear 34 is located on a radially outer side of the plurality of first planetary gears 32 and is fixed to the housing assembly 5, an orbit for the revolution of the plurality of first planetary gears 32 is formed between the first ring gear 34 and the first sun gear 31, and the first ring gear 34 is always meshed with the plurality of first planetary gears 32. The first sun gear 31, the first planetary gears 32, the first planetary gear carrier 33, and the first ring gear 34 mentioned above constitute a first planetary row.

In the present embodiment, the braking mechanism 4 is a caliper disc type braking mechanism, which is capable of generating friction torque that prevents the wheels from rotating. Specifically, as shown in FIG. 1A to FIG. 1C, the braking mechanism 4 comprises a brake disc assembly 41 and a brake caliper assembly 42 which are assembled together. The brake disc assembly 41 comprises a brake disc 411, a spline hub 412 and a thermal insulation pad 413 which are assembled together. The brake disc 411 and the spline hub 412 are fixed together by a connecting member, the spline hub 412 is mounted in a torsion resistant manner at an end portion on the other side in the axial direction of the output shaft 1 via a spline structure, and thus the brake disc 411 is mounted in a torsion resistant manner on the output shaft 1 via the spline hub 412, such that friction torque generated by the brake disc 411 and the brake caliper assembly 42 is capable of being transmitted to the output shaft 1. The thermal insulation pad 413 is located between the brake disc 411 and the spline hub 412, such that the brake disc 411 is not in direct contact with the spline hub 412, thereby being capable of reducing the transmission of heat generated by the brake disc 411 during the generation of friction torque to the spline hub 412. The brake caliper assembly 42 may comprise a motor, a brake piston and a brake lining, the brake piston is capable of being driven to move through the motor and further driving the brake lining to clamp the brake disc 411, thereby generating friction torque that prevents the wheels from rotating to achieve braking.

Further, the brake caliper assembly 42 comprises a portion on one side in the axial direction, located on one side in the axial direction, relative to the brake disc assembly 41, and a portion on the other side in the axial direction, located on the other side in the axial direction, relative to the brake disc assembly 41. The portion on one side in the axial direction is located on a radially outer side of the planetary gear reduction mechanism 3, and the portion on one side in the axial direction basically completely overlaps the planetary gear reduction mechanism 3 in the radial direction R. The portion on the other side in the axial direction extends out of a third space S3 described later, to extend to an outside of the housing assembly 5.

In the present embodiment, as shown in FIG. 1A to FIG. 1C, the housing assembly 5 is integrally formed in a cylindrical shape. Specifically, the housing assembly 5 comprises a housing main body 51, a first cover 52, a second cover 53, and a back plate 54 which are assembled together with each other. Openings open toward two sides in the axial direction are formed on the housing main body 51, the first cover 52 is fixed to the housing main body 51 for partially closing the openings of the housing main body 51 that are open toward one side in the axial direction, the back plate 54 is fixed to the housing main body 51 for partially closing the openings of the housing main body 51 that are open toward the other side in the axial direction, and the second cover 53 is located inside the housing main body 51 and is fixed to the housing main body 51 for surrounding a space defining the planetary gear reduction mechanism 3 with a partition wall of the housing main body 51.

Further, by using the housing main body 51, the first cover 52, the second cover 53, and the back plate 54, the housing assembly 5 defines a first space S1, a second space S2, and a third space S3 which are partitioned from each other. As shown in FIG. 1A, a radially outer side portion of the first space S1 and a radially outer side portion of the third space S3 are adjacent to each other in the axial direction A. The radially inner side portion of the first space S1 and the radially inner side portion of the third space S3 are partitioned by the second space S2. A vast majority of the second space S2 overlaps the third space S3 in the radial direction R, and the rest of the second space S2 overlaps the first space S1 in the radial direction R. The stator 21, the rotor 22, and the rotor bracket 23 of the motor 2 are accommodated and mounted in the first space S1, and the motor shaft 24 extends from a position where the first space S1 is located to a position where the second space S2 is located in the axial direction A. At least a part of the structure of the planetary gear reduction mechanism 3 is accommodated and mounted in the second space S2. At least a part of the structure of the braking mechanism 4 is accommodated in the third space S3, and it can be actually considered that the spline hub 412 cooperates with the second cover 53 to be used for separating the second space S2 from the third space S3.

In the present embodiment, as shown in FIG. 1A and FIG. 1C, the steering knuckle 6 is formed as a flanged shaft extending along the axial direction A. Specifically, the steering knuckle 6 comprises a second flange portion 61 and a second shaft portion 62 which are formed into a whole. The second flange portion 61 extends from an end on the other side in the axial direction of the second shaft portion 62 toward a radially outer side, and the second flange portion 61 extends continuously over an entire circumference along the circumferential direction. A plurality of mounting holes are formed on the second flange portion 61, and mounting members, for example, bolts, passing through the plurality of mounting holes are capable of fixing the second flange portion 61 together with the back plate 54 of the housing assembly 5, and the back plate 54 is further mounted together with a suspension system of the vehicle. The second shaft portion 62 extends in a straight line shape from an inner circumferential portion of the second flange portion 61 toward one side in the axial direction. The second shaft portion 62 extends into the inside of the first shaft portion 12 of the output shaft 1.

In the present embodiment, as shown in FIG. 1A, the wheel bearing 7 may be a double-row tapered roller bearing. The wheel bearing 7 comprises an inner ring, an outer ring, and a rolling body, wherein the inner ring and the steering knuckle 6 are fixed, the outer ring and the output shaft 1 are fixed, and the rolling body is located between the inner ring and the outer ring. The second shaft portion 62 of the steering knuckle 6 is capable of supporting the first shaft portion 12 of the output shaft 1 through the wheel bearing 7.

In this way, in the hub motor drive system according to the first embodiment of the present application, the following operating modes can be achieved.

In a first operating mode, torque is transmitted toward the hubs by the motor 2 to drive wheels to rotate. In this operating mode, a transmission path of torque from the motor 2 is as follows: rotor 22→rotor bracket 23→motor shaft 24→first sun gear 31→first planetary gear 32→first planetary gear carrier 33→output shaft 1→hub.

In a second operating mode, braking energy recovery is performed during vehicle braking. In this operating mode, a transmission path of torque from the hub is as follows: hub→output shaft 1→first planetary gear carrier 33→first planetary gear 32→first sun gear 31→motor shaft 24→rotor bracket 23→rotor 22.

In a third operating mode, friction torque generated by the braking mechanism 4 during vehicle braking is transmitted to the hubs, and kinetic energy of the vehicle is converted into thermal energy of the braking mechanism 4. In this operating mode, a transmission path of friction torque from the braking mechanism 4 is as follows: brake disc 411→spline hub 412→output shaft 1→hub.

In the hub motor drive system according to the first embodiment of the present application, the motor 2 is arranged side by side with the braking mechanism 4 in the axial direction A, and other components basically completely overlap the motor 2 and the braking mechanism 4 in the radial direction R. Therefore, an axial length of the entire hub motor drive system is capable of being determined by the motor 2 and the braking mechanism 4, thereby reducing axial dimensions compared with a hub motor drive system in the prior art, and reducing the adverse effects of the axial dimensions of the hub motor drive system on the dimensions of the wheels and the overall layout of the vehicle (the layout of the suspension system). In particular, the planetary gear reduction mechanism 3 does not additionally increase the axial length of the entire hub motor drive system.

A hub motor drive system according to a second embodiment of the present application will be described below in combination with the accompanying drawings of the specification.

### The Hub Motor Drive System According to the Second Embodiment of the Present Application

The structure of the hub motor drive system according to the second embodiment of the present application is roughly the same as the structure of the hub motor drive system according to the first embodiment of the present application, with differences between them mainly described below.

In the present embodiment, as shown in FIG. 2A to FIG. 2C, the motor 2 is an axial flow motor (or called an axial magnetic field/magnetic flux motor). In the motor 2, the rotor bracket 23 may not be separately provided, the rotor 22 is in direct transmission connection with the motor shaft 24, and thus the rotor 22 is in indirect transmission connection with the first sun gear 31 of the planetary gear reduction mechanism 3 via the motor shaft 24.

In the present embodiment, as shown in FIG. 2A to FIG. 2C, the hub motor drive system further comprises an inverter assembly 8 for the motor 2, and the inverter assembly 8 comprises necessary electronic devices and circuit connection structures. The inverter assembly 8 is located on a radially outer side of the planetary gear reduction mechanism 3. In addition, the inverter assembly 8 is arranged side by side with the portion on one side in the axial direction of the brake caliper assembly 42 in the circumferential direction, that is, the inverter assembly 8 and the portion on one side in the axial direction of the brake caliper assembly 42 are located at the same position in the axial direction A. In the present embodiment, the inverter assembly 8 is accommodated and mounted in the third space S3.

By adopting the above-mentioned structure, the same effects as those of the first embodiment can be achieved. Furthermore, even if the inverter assembly 8 is provided, the axial dimensions of the entire hub motor drive system are not additionally increased. Further, the inverter assembly 8 may share a cooling system with the motor 2.

A hub motor drive system according to a third embodiment of the present application will be described below in combination with the accompanying drawings of the specification.

### The Hub Motor Drive System According to the Third Embodiment of the Present Application

The structure of the hub motor drive system according to the third embodiment of the present application is roughly the same as the structure of the hub motor drive system according to the first embodiment of the present application, with differences between them mainly described below.

In the present embodiment, as shown in FIG. 3A, the motor 2 is an axial flow motor. In the motor 2, the rotor bracket 23 is not provided separately, the rotor 22 is in direct transmission connection with the motor shaft 24, and thus the rotor 22 is in indirect transmission connection with the first sun gear 31 of the planetary gear reduction mechanism 3 via the motor shaft 24.

In the present embodiment, the planetary gear reduction mechanism 3 is capable of transmitting torque from the motor 2 to the output shaft 1. As shown in FIG. 3A, the planetary gear reduction mechanism 3 not only comprises the first planetary row, but also comprises a second sun gear 35, second planetary gears 36, a second planetary gear carrier 37, and a second ring gear 38 which are assembled together. As described above, the second sun gear 35 is in direct transmission connection with the first planetary gear carrier 33 of the first planetary row. The plurality of second planetary gears 36 are located on a radially outer side of the second sun gear 35 and are uniformly distributed along the circumferential direction, and each second planetary gear 36 is always meshed with the second sun gear 35, such that each second planetary gear 36 is capable of rotating around its respective central axis and revolving around the second sun gear 35 as the second sun gear 35 rotates. The second planetary gear carrier 37 is located on a radially outer side of the second sun gear 35, the plurality of second planetary gears 36 are mounted on the second planetary gear carrier 37, and the second planetary gear carrier 37 can be in direct transmission connection with the output shaft 1 through direct fixation or a spline structure. As the plurality of second planetary gears 36 revolve, the second planetary gear carrier 37 is capable of being driven to rotate, thereby driving the output shaft 1 to rotate. The second ring gear 38 is located on a radially outer side of the plurality of second planetary gears 36 and is fixed to the housing assembly 5, an orbit for the revolution of the plurality of second planetary gears 36 is formed between the second ring gear 38 and the second sun gear 35, and the second ring gear 38 is always meshed with the plurality of second planetary gears 36. The second sun gear 35, the second planetary gears 36, the second planetary gear carrier 37, and the second ring gear 38 mentioned above constitute a second planetary row, the second planetary row and the first planetary row constitute the entire planetary gear reduction mechanism 3, the second planetary row is arranged side by side with the first planetary row in the axial direction A, and the second planetary row is located on the other side in the axial direction relative to the first planetary row.

In the present embodiment, as shown in FIG. 3A and FIG. 3B, the braking mechanism 4 comprises a brake disc assembly 41 and a brake caliper assembly 42. Specifically, the brake disc assembly 41 omits the spline hub 412 and the thermal insulation pad 413 described in the first embodiment and thus comprises a brake disc 411 fixedly mounted directly on the output shaft 1. The brake caliper assembly 42 comprises a brake caliper housing 421, a brake piston 422, and a brake lining 423. The brake caliper housing 421 may be fixed to the back plate 54 of the housing assembly 5, and the brake piston 422 may be located in a cylinder chamber formed in the brake caliper housing 421. The brake piston 422 is capable of being driven to move through a power source, and thus the brake lining 423 is driven by the brake piston 422 to clamp the brake disc 411, thereby generating friction torque that prevents the wheels from rotating to achieve braking. In the present embodiment, two sides of the brake disc 411 both have a brake piston 422 and a brake lining 423, so that a portion on one side in the axial direction and a portion on the other side in the axial direction of the brake disc 411 both comprise one brake piston 422 and one brake lining 423.

Further, in the hub motor drive system according to the third embodiment of the present application, following operating modes can be realized.

In a first operating mode, torque is transmitted toward the hubs by the motor 2 to drive wheels to rotate. In this operating mode, a transmission path of torque from the motor 2 is as follows: rotor 22→motor shaft 24→first sun gear 31→first planetary gear 32→first planetary gear carrier 33→second sun gear 35→second planetary gear 36→second planetary gear carrier 37→output shaft 1→hub.

In a second operating mode, braking energy recovery is performed during vehicle braking. In this operating mode, a transmission path of torque from the hub is as follows: hub→output shaft 1→second planetary gear carrier 37→second planetary gear 36→second sun gear 35→first planetary gear carrier 33→first planetary gear 32→first sun gear 31→motor shaft 24→rotor 22.

In a third operating mode, friction torque generated by the braking mechanism 4 during vehicle braking is transmitted to the hubs, and kinetic energy of the vehicle is converted into thermal energy of the braking mechanism 4. In this operating mode, a transmission path of friction torque from the braking mechanism 4 is as follows: brake disc 411→output shaft 1→hub.

By adopting the above-mentioned structure, the same effects as those of the first embodiment can be achieved. Furthermore, the second planetary row and the first planetary row constitute the entire planetary gear reduction mechanism 3, thereby greatly changing a transmission ratio and increasing the so-called torque density.

A hub motor drive system according to a fourth embodiment of the present application will be described below in combination with the accompanying drawings of the specification.

### The Hub Motor Drive System According to the Fourth Embodiment of the Present Application

The structure of the hub motor drive system according to the fourth embodiment of the present application is roughly the same as the structure of the hub motor drive system according to the third embodiment of the present application, with differences between them mainly described below.

In the present embodiment, as shown in FIG. 4A, the motor 2 is a radial magnetic field motor, which has a structure the same as that of the motor 2 in the first embodiment.

In the present embodiment, as shown in FIG. 4A to FIG. 4C, the hub motor drive system further comprises an inverter assembly 8 for the motor 2, and the inverter assembly 8 comprises necessary electronic devices and circuit connection structures. The inverter assembly 8 is located on a radially outer side of the planetary gear reduction mechanism 3. In addition, the inverter assembly 8 is arranged side by side with the portion on one side in the axial direction of the brake caliper assembly 42 in the circumferential direction, that is, the inverter assembly 8 and the portion on one side in the axial direction of the brake caliper assembly 42 are located at the same position in the axial direction A. In the present embodiment, the inverter assembly 8 is accommodated and mounted in the third space S3.

By adopting the above-mentioned structure, the same effects as those in the third embodiment can be achieved. Furthermore, even if the inverter assembly 8 is provided, the axial dimensions of the entire hub motor drive system are not additionally increased. Further, the inverter assembly 8 may further share the cooling system with the motor 2.

The present application is not limited to the above-mentioned embodiments, and those skilled in the art could make various modifications to the above-mentioned embodiments under the teaching of the present application without departing from the scope of the present application. In addition, further explanation is provided as follows.
i. The present application further provides a vehicle comprising the above-mentioned hub motor drive system, and the vehicle may particularly be an electric vehicle having two or more wheels. In one optional example of the vehicle according to the present application, the vehicle comprises four wheels, and the hub motor drive system is mounted in two or four wheels.
ii. It can be understood that in order to ensure the normal operation of the motor shaft 24 and the output shaft 1, the hub motor drive system further comprises a plurality of other bearings in addition to the wheel bearing 7. For example, in various embodiments, a deep groove ball bearing as a support bearing is provided between the motor shaft 24 and the housing assembly 5.

In addition, in order to achieve necessary partition and sealing effects, a sealing assembly and a sealing ring can be provided as needed in the hub motor drive system of the present application.
iii. In the hub motor drive system of the present application, the motor 2 and the planetary gear reduction mechanism 3 are located between the hub or a spoke and the braking mechanism 4 in the axial direction A. In addition, the brake disc assembly 41 of the braking mechanism 4 is mounted on the output shaft 1 and thus has the same speed as the output shaft 1.
iv. It can be understood that in the accompanying drawings corresponding to the third embodiment and the fourth embodiment, each constituent component of the housing assembly 5 is shown in one whole for simplifying the display. In addition, in various embodiments of the present application, the first space S1, the second space S2, and the third space S3 can be partitioned by the housing assembly 5, and the brake caliper assembly 42 of the braking mechanism 4 is at least partially located outside the third space S3. It can be understood that the first space S1 and the second space S2 mentioned above may be closed spaces, and the third space S3 mentioned above may be a non-closed space.
v. It can be understood that the second shaft portion 62 of the steering knuckle 62 is inserted into the first shaft portion 11 of the output shaft 1, such that the first shaft portion 12 of the output shaft 1 partially overlaps the second shaft portion 62 of the steering knuckle 6 in the radial direction R, and the overall lengths of both the output shaft 1 and the steering knuckle 6 in the axial direction A may not exceed or slightly exceed an axial length defined by the motor 2 and the braking mechanism 4.

### REFERENCE NUMERALS

1 Output shaft;
11 First flange portion;
12 First shaft portion;
2 Motor;
21 Stator;
22 Rotor;
23 Rotor bracket;
24 Motor shaft;
3 Planetary gear reduction mechanism;
31 First sun gear;
32 First planetary gear;
33 First planetary gear carrier;
34 First ring gear;
35 Second sun gear;
36 Second planetary gear;
37 Second planetary gear carrier;
38 Second ring gear;
4 Braking mechanism;
41 Brake disc assembly;
411 Brake disc;
412 Spline hub;
413 Thermal insulation pad;
42 Brake caliper assembly;
421 Brake caliper housing;
422 Brake piston;
423 Brake lining;
5 Housing assembly;
51 Housing main body;
52 First cover;
53 Second cover;
54 Back plate;
S1 First space;
S2 Second space;
S3 Third space;
6 Steering knuckle;
61 Second flange portion;
62 Second shaft portion;
7 Wheel bearing;
8 Inverter assembly;
A Axial direction;
R Radial direction.

1. A hub motor drive system, having an axial direction, a radial direction, and a circumferential direction, wherein the hub motor drive system comprises:
an output shaft, an end portion on one side of an axial direction of the output shaft being used for being fixed to hubs of wheels;
a motor comprising a stator and a rotor;
planetary gear reduction mechanism being located on the other side in the axial direction relative to the motor and being arranged side by side with the motor in the axial direction, the planetary gear reduction mechanism comprising a sun gear and planetary gear carriers the sun gear being in transmission connection with the rotor, and the planetary gear carriers being in transmission connection with the output shaft; and
braking mechanism being located on the other side in the axial direction relative to the motor and being arranged side by side with the motor in the axial direction, the braking mechanism comprising a brake disc assembly and a brake caliper assembly, the brake disc assembly being mounted in a torsion resistant manner on the output shaft, the brake caliper assembly being capable of generating friction torque with the brake disc assembly in a controlled manner, the brake caliper assembly overlapping the planetary gear reduction mechanism in the radial direction, and the brake disc assembly overlapping the planetary gear reduction mechanism in the axial direction.

2. The hub motor drive system according to claim 1, wherein the brake caliper assembly comprises a portion on one side in the axial direction, located on one side in the axial direction, relative to the brake disc assembly, the portion on one side in the axial direction is located on a radially outer side of the planetary gear reduction mechanism, and the portion on one side in the axial direction overlaps the planetary gear reduction mechanism in the radial direction.

3. The hub motor drive system according to claim 2, wherein
the brake disc assembly comprises a brake disc a spline hub and a thermal insulation pad assembled together, the brake caliper assembly is used for generating friction torque with the brake disc the brake disc is in indirect transmission connection with the output shaft via the spline hub and the thermal insulation pad is located between the brake disc and the spline hub or
the brake disc assembly comprises a brake disc the brake caliper assembly is used for generating friction torque with the brake disc and the brake disc is in direct transmission connection with the output shaft.

4. The hub motor drive system according to claim 1, further comprising a housing assembly, wherein the housing assembly defines a first space, a second space, and a third space partitioned from each other, the motor is at least partially accommodated and mounted in the first space, the planetary gear reduction mechanism is at least partially accommodated and mounted in the second space, the braking mechanism is at least partially accommodated in the third space,
a radially outer side portion of the first space and a radially outer side portion of the third space are adjacent to each other in the axial direction, and a radially inner side portion of the first space and a radially inner side portion of the third space are partitioned by the second space.

5. The hub motor drive system according to claim 4, wherein the second space overlaps both the first space and the third space in the radial direction.

6. The hub motor drive system according to claim 4, wherein the housing assembly comprises a housing main body and a back plate, the back plate is assembled to the housing main body from the other side in the axial direction, the brake caliper assembly is fixed to the back plate, and the back plate is used for being mounted on a suspension system of a vehicle.

7. The hub motor drive system according to claim 6, further comprising a steering knuckle and a wheel bearing,
wherein the output shaft comprises a first flange portion and a first shaft portion fixed to each other, the first shaft portion extends from the first flange portion toward the other side in the axial direction, the first flange portion is used for being fixed to the hubs,
the steering knuckle comprises a second flange portion and a second shaft portion fixed to each other, the second flange portion and the back plate are fixed, the second shaft portion extends from the second flange portion toward one side in the axial direction and is inserted into the first shaft portion,
and the wheel bearing is located between the first shaft portion and the second shaft portion.

8. The hub motor drive system according to claim 1, wherein
the motor is a radial magnetic field motor, the motor further comprises a rotor bracket and a motor shaft, and the rotor is in indirect transmission connection with the sun gear via the rotor bracket and the motor shaft; or
the motor is an axial flow motor, the motor further comprises a motor shaft, and the rotor is in indirect transmission connection with the sun gear via the motor shaft.

9. The hub motor drive system according to claim 8, further comprising an inverter assembly for the motor, wherein the inverter assembly is located on a radially outer side of the planetary gear reduction mechanism and is arranged side by side with the end portion on one side in the axial direction of the brake caliper assembly in the circumferential direction.

10. A vehicle, comprising the hub motor drive system according to claim 1.
